(19) United States
(12) Patent Application Publication
(10) Pub. No.: US 2022/0259023 A1
(43) Pub. Date: Aug. 18, 2022

(54) TRANSPORT SYSTEM AND TRANSPORT METHOD

(71) Applicant: TOYOTA JIDOSHA KABUSHIKI KAISHA, Toyota-shi (JP)

(72) Inventors: Kunihiro IWAMOTO, Nagakute-shi (JP); Yuta ITOZAWA, Nagoya-shi (JP); Hirotaka KOMURA, Tokyo (JP); Yutaro TAKAGI, Tokyo (JP)

(21) Appl. No.: 17/545,326

(22) Filed: Dec. 8, 2021

(30) Foreign Application Priority Data
Feb. 16, 2021 (JP) 2021-022726

(51) Int. Cl. B66F 9/12; B66F 9/075; B65G 1/04

(52) U.S. Cl. CPC B66F 9/12; B65G 1/0435; B66F 9/0755

(57) ABSTRACT

A transport system transports an object using a transport robot. The transport robot includes a top plate on which the object is placed, an arm portion that moves the object in a horizontal direction so as to place the object on the top plate or remove the object from the top plate, a sensor that is disposed on the top plate and detects that the object has reached a predetermined position on the top plate, and a control unit for controlling an operation of the arm portion. The control unit places the object on the top plate based on a detection result of the sensor, or removes the object from the top plate based on the detection result of the sensor.

### CROSS-REFERENCE TO RELATED APPLICATION

This application claims priority to Japanese Patent Application No. 2021-022726 filed on Feb. 16, 2021, incorporated herein by reference in its entirety.

### BACKGROUND

### 1. Technical Field

The present disclosure relates to a transport system and a transport method.

### 2. Description of Related Art

Japanese Unexamined Patent Application Publication No. 2019-091770 (JP 2019-091770 A) discloses a technique capable of connecting a cart and an unmanned transport machine to enable moving a transported object in a horizontal direction.

### SUMMARY

In such a technique, it is desired to move the transported object more accurately in order to suppress dropping of the transported object.

The present disclosure has been made to solve such an issue, and an object of the present disclosure is to provide a transport system and a transport method capable of reducing the risk of dropping a transported object.

A transport system according to the present embodiment is a transport system for transporting an object using a transport robot. The transport robot includes a top plate on which the object is placed, an arm portion that moves the object in a horizontal direction so as to place the object on the top plate or remove the object from the top plate, a sensor that is disposed on the top plate and detects that the object has reached a predetermined position on the top plate, and a controller for controlling an operation of the arm portion. The controller places the object on the top plate based on a detection result of the sensor, or removes the object from the top plate based on the detection result of the sensor.

A transport method in the present embodiment is a transport method for transporting an object using a transport robot. The transport robot includes a top plate on which the object is placed, an arm portion that moves the object in a horizontal direction so as to place the object on the top plate or remove the object from the top plate, and a sensor that is disposed on the top plate and detects that the object has reached a predetermined position on the top plate. The transport method includes a step for placing the object on the top plate based on a detection result of the sensor, or removing the object from the top plate based on the detection result of the sensor.

The present disclosure can provide a transport system and a transport method capable of reducing the risk of dropping a transported object.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a configuration of a transport robot according to an embodiment;

FIG. 2 is a side view showing a configuration of the transport robot according to the embodiment;

FIG. 3 is a block diagram showing a function of the transport robot according to the embodiment;

FIG. 4 is a schematic plan view showing a state in which the transport robot contracts an arm;

FIG. 5 is a schematic plan view showing a state in which the transport robot expands the arm;

FIG. 6 is a schematic plan view showing a state in which the transport robot expands the arm and then a protruding portion is directed upward;

FIG. 7 is a schematic view showing a rack and an object that is a transport target housed in the rack;

FIG. 8 is a perspective view of the object to be transported by the transport robot;

FIG. 9 is a schematic side view showing a state before the transport robot according to the embodiment takes out the object;

FIG. 10 is a schematic side view showing a state in which the transport robot according to the embodiment has engaged the object with an arm portion;

FIG. 11 is a schematic side view showing a state in which the transport robot according to the embodiment has moved the object to a predetermined position on a top plate;

FIG. 12 is a schematic side view showing a state in which the transport robot according to the embodiment has placed the object on the top plate;

FIG. 13 is a schematic bottom view illustrating a shape of the object transported by the transport robot;

FIG. 14 is a schematic plan view showing a state in which a plurality of sensors is disposed on the top plate of the transport robot according to the embodiment;

FIG. 15 is a flowchart illustrating a flow of a transport method according to the embodiment;

FIG. 16 is a schematic plan view showing a state before the transport robot according to the embodiment pulls out the object;

FIG. 17 is a schematic plan view showing a state in which the transport robot according to the embodiment has moved the object to a detection position of a sensor 150a;

FIG. 18 is a schematic plan view showing a state in which the transport robot according to the embodiment has moved the object to a detection position of a sensor 150b; and

FIG. 19 is a schematic plan view showing a state in which the transport robot according to the embodiment has moved the object to a detection position of a sensor 150c.

### DETAILED DESCRIPTION OF EMBODIMENTS

Hereinafter, the present disclosure will be described through embodiments of the disclosure, but the disclosure according to the scope of the claims is not limited to the following embodiments. Not all of the configurations described in the embodiment are indispensable as means for solving the problem.

A transport system according to the embodiment will be described with reference to the drawings. The transport system according to the embodiment includes a transport robot 10. The transport system is a transport system in which the transport robot 10 transports an object. The transport system may further include a rack for storing the object transported by the transport robot.

The transport system may be provided with a server that controls the travel of the transport robot 10, but the transport robot 10 may generate a transport route by itself to perform autonomous movement. A system in which the processing is completed within the transport robot 10 that does not include a server can also be included in the transport system according to the embodiment.

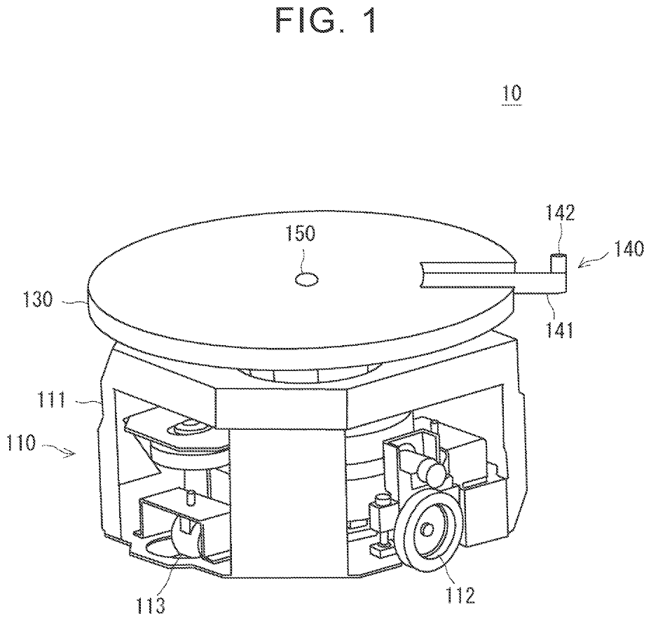

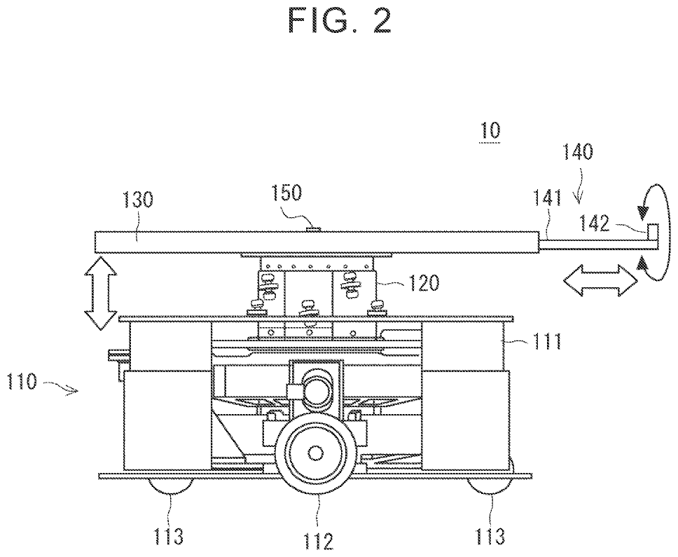

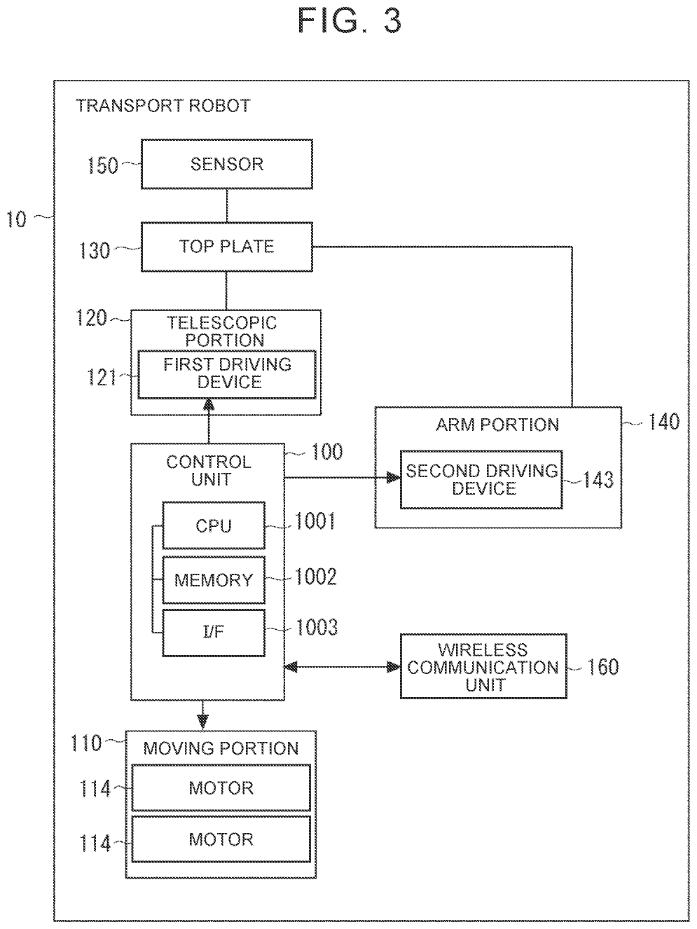

FIG. 1 is a perspective view showing a schematic configuration of the transport robot 10 included in the transport system according to the embodiment. FIG. 2 is a schematic side view showing the schematic configuration of the transport robot 10. FIG. 3 is a block diagram showing a schematic system configuration of the transport robot 10.

The transport robot 10 includes a movable moving portion 110, a telescopic portion 120 that expands and contracts in the vertical direction, a top plate 130 for supporting a placed object, an arm portion 140, a control unit 100, a sensor 150, and a wireless communication unit 160. The control unit 100 controls the transport robot 10 including the control of the moving portion 110, the telescopic portion 120, and the arm portion 140.

The moving portion 110 includes a robot body 111, a pair of right and left drive wheels 112 and a pair of front and rear driven wheels 113 that are rotatably provided on the robot body 111, and a pair of motors 114 that rotates and drives the respective drive wheels 112. Each motor 114 rotates the corresponding drive wheel 112 via a speed reducer or the like. Each motor 114 rotates the corresponding drive wheel 112 in accordance with a control signal from the control unit 100, thereby enabling forward movement, backward movement, and rotation of the robot body 111. With this configuration, the robot body 111 can move to a given position. Note that, the configuration of the moving portion 110 is an example, and the present disclosure is not limited to this. For example, the number of the drive wheels 112 and the driven wheels 113 of the moving portion 110 may be any number, and any configuration can be applied as long as the robot body 111 can be moved to a given position.

The telescopic portion 120 is a telescopic mechanism that expands and contracts in the vertical direction. The telescopic portion 120 may be configured as a telescopic-type expansion and contraction mechanism. The top plate 130 is provided at the upper end of the telescopic portion 120, and the top plate 130 is raised or lowered by the operation of the telescopic portion 120. The telescopic portion 120 includes a first driving device 121 such as a motor, and expands and contracts as the first driving device 121 is driven. That is, the top plate 130 is raised or lowered as the first driving device 121 is driven. The first driving device 121 is driven in response to a control signal from the control unit 100. Note that, in the transport robot 10, any known mechanism for controlling the height of the top plate 130 provided on the upper side of the robot body 111 may be used instead of the telescopic portion 120.

The top plate 130 is provided at the upper end of the telescopic portion 120. The top plate 130 is raised and lowered by a driving device such as a motor. The top plate 130 is used for placing an object to be transported by the transport robot 10. For transportation, the transport robot 10 moves together with the object while the object is supported by the top plate 130. As a result, the transport robot 10 transports the object.

The object is placed on the top plate 130. The top plate 130 may include, for example, a plate material serving as an upper surface (placing surface) and a plate material serving as a lower surface. A space for accommodating the arm portion 140 may be provided between the upper surface and the lower surface. The shape of the top plate 130 is, for example, a flat disk shape, but any other shape may be used. The top plate 130 may be provided with a notch along the moving line of the arm portion 140.

The top plate 130 is provided with the arm portion 140 that moves the object in the horizontal direction so as to place the object to be transported on the top plate 130 or remove the object from the top plate 130. The arm portion 140 has a shaft portion 141 that can be expanded and contracted along the axis, and a protruding portion 142. The protruding portion 142 extends from the shaft portion 141 in a direction different from that of the shaft portion 141 and engages with a groove provided on the bottom surface of the object. The protruding portion 142 may extend from the tip of the shaft portion 141 in the direction perpendicular to the shaft portion 141. That is, the arm portion 140 may have an L-shape.

Further, the arm portion 140 is provided with a second driving device 143 that expands and contracts the arm portion 140 in the horizontal direction (that is, the direction along the shaft portion 141, in other words, the longitudinal direction of the arm), based on the control signal received from the control unit 100. The second driving device 143 may further have a function of rotating the arm portion 140 with the shaft portion 141 as a rotation axis. The second driving device 143 includes, for example, a motor and a linear guide, but any known mechanism for performing the above operations may be used as the second driving device 143. The expansion and contraction mechanism of the arm portion 140 is not limited to the guide rail mechanism.

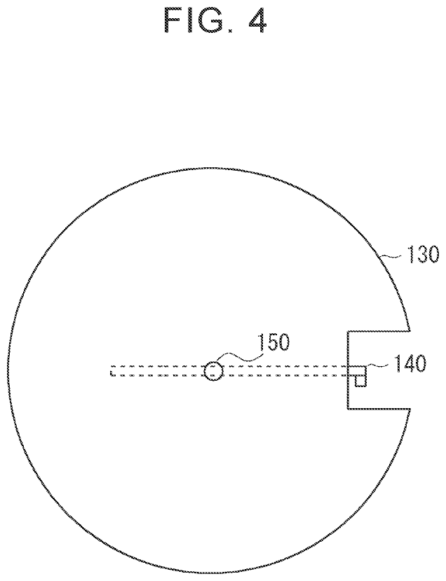

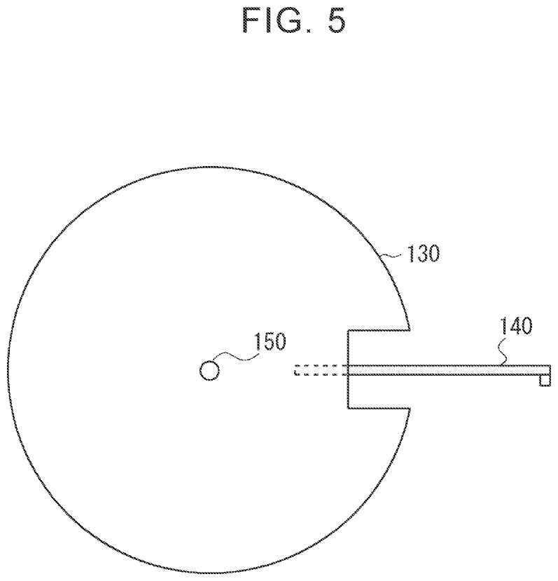

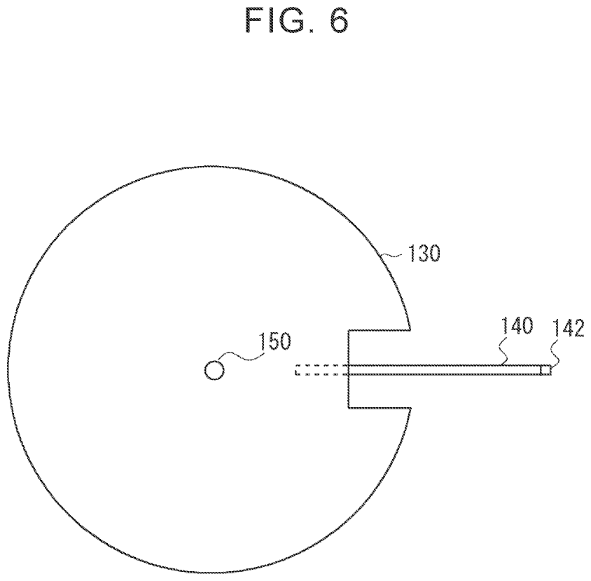

Here, the movement of the arm portion 140 is shown in FIGS. 4 to 6. FIG. 4 is a schematic plan view showing a state in which the arm portion 140 is contracted. FIG. 5 is a schematic plan view showing a state in which the arm portion 140 is expanded. FIG. 6 is a schematic plan view showing a state in which the arm portion 140 is expanded and then the arm portion 140 is rotated so that the protruding portion 142 is directed upward.

In this way, the arm portion 140 can be expanded and contracted in the horizontal direction. Further, as described above, the arm portion 140 may be capable of rotating the protruding portion 142 with the shaft portion 141 as the rotation axis. The transport robot 10 may further have a function of detecting an abnormality in the rotation angle of the protruding portion 142 of the arm portion 140.

Returning to FIGS. 1 to 4, the sensor 150 is disposed on the top plate 130. The number of sensors 150 may be plural. The sensor 150 detects that the object has reached a predetermined position on the top plate 130. The sensor 150 may detect the object using light, for example. The sensor 150 is, for example, a photoreflector, and may detect the object by receiving light reflected by the object. Further, the sensor 150 may detect the object by reading a radio frequency identifier (RFID) attached to the bottom surface of the object. Based on the detection result of the sensor 150, the transport robot 10 can confirm that the object has moved to the position where the sensor 150 is disposed.

The wireless communication unit 160 is a circuit for performing wireless communication to communicate with a server or another robot as needed, and includes, for example, a wireless transmission and reception circuit and an antenna. Note that, when the transport robot 10 does not communicate with other devices, the wireless communication unit 160 may be omitted.

The control unit 100 is a device that controls the transport robot 10, and includes a processor 1001, a memory 1002, and an interface (IF) 1003. The processor 1001, the memory 1002, and the interface 1003 are connected to each other via a data bus or the like.

The interface 1003 is an input and output circuit used for communicating with other devices such as the moving portion 110, the telescopic portion 120, the arm portion 140, and the wireless communication unit 160.

The memory 1002 is composed of, for example, a combination of a volatile memory and a non-volatile memory. The memory is used to store software (computer program) including one or more commands to be executed by the processor, data used for executing various processes of the transport robot, and the like.

The processor 1001 may be, for example, a microprocessor, a microprocessor unit (MPU), or a central processing unit (CPU). The processor 1001 may include a plurality of processors. As described above, the control unit 100 is a device that functions as a computer.

The above-mentioned program can be stored and supplied to a computer using various types of non-transitory computer-readable media. The non-transitory computer-readable media include various types of tangible recording media. Examples of the non-transitory computer-readable media include magnetic recording media (e.g. flexible disks, magnetic tapes, hard disk drives), magneto-optical recording media (e.g. magneto-optical disks), compact disc read-only memory (CD-ROM), compact disc recordable (CD-R), compact disc rewritable (CD-R/W), and semiconductor memory (e.g. mask ROM, programmable ROM (PROM), erasable PROM (EPROM), flash ROM, random access memory (RAM)). Further, the program may be supplied to the computer using various types of transitory computer-readable media. Examples of the transitory computer-readable media include electrical signals, optical signals, and electromagnetic waves. The transitory computer-readable media can supply the program to the computer via a wired communication path such as an electric wire and an optical fiber, or a wireless communication path.

Next, the processes of the control unit 100 will be described. The control unit 100 can control the rotation of each drive wheel 112 and move the robot body 111 to a given position by transmitting the control signal to each motor 114 of the moving portion 110.

Note that, the control unit 100 may control movement of the transport robot 10 by executing known control such as feedback control or robust control based on rotation information of the drive wheels 112 detected by rotation sensors provided on the drive wheels 112. Further, the control unit 100 may cause the transport robot 10 to move autonomously by controlling the moving portion 110 based on distance information detected by a distance sensor such as a camera or an ultrasonic sensor provided on the transport robot 10 and map information on moving environment.

Further, the control unit 100 can control the height of the top plate 130 by transmitting the control signal to the first driving device 121 of the telescopic portion 120.

The control unit 100 can control the expansion and contraction of the arm portion 140 in the horizontal direction by transmitting the control signal to the second driving device 143. Here, the control unit 100 places the object on the top plate 130 based on the detection result of the sensor 150, or removes the object from the top plate 130 based on the detection result of the sensor 150. The control unit 100 may move the object while confirming the detection result of the sensor 150. The details of the method of moving the object based on the detection result of the sensor 150 will be described later.

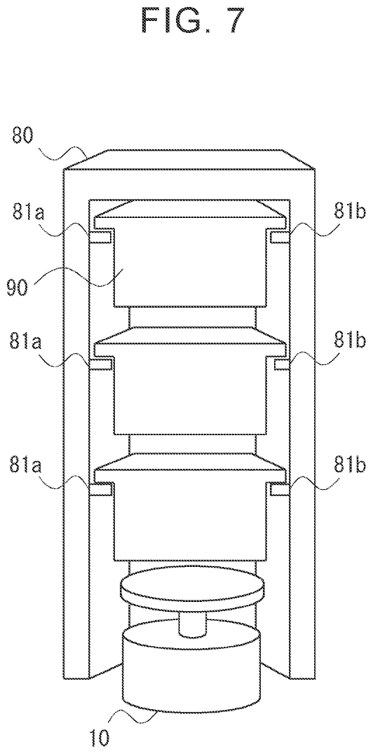

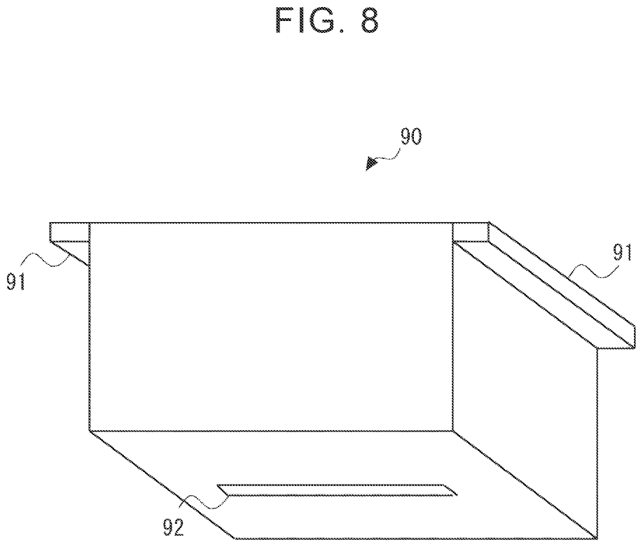

Here, an object that is a transport target of the transport robot 10 will be specifically described. FIG. 7 is a schematic view showing a rack 80 and an object 90 that is a transport target housed in the rack 80. Note that FIG. 7 also shows the transport robot 10 positioned in front of the rack 80. FIG. 8 is a perspective view showing the front surface, the bottom surface, and the side surface of the object 90. As shown in FIG. 7, the transport robot 10 moves to a position close to the rack 80 when the transport robot 10 transfers the object 90 on the rack 80 to the top plate 130 or when the transport robot 10 transfers the object 90 placed on the top plate 130 to the rack 80. More specifically, for example, the transport robot 10 moves to a position in front of the rack 80 and at an intermediate point between a pair of rails 81a, 81b of the rack 80.

The rack 80 includes the rails 81a, 81b that support respective sides of the object 90. The pair of the rails 81a, 81b is provided in parallel at the same height. One side of the object 90 housed in the rack 80 is supported by the rail 81a, and the other side of the object 90 is supported by the rail 81b. The rails 81a, 81b are both provided to extend from the front surface to the back surface of the rack 80.

For example, as shown in FIG. 8, flanges 91 are provided on respective sides of the object 90. The object 90 is supported in the rack 80 as the flanges 91 are supported by the rails 81a, 81b from below. Note that, the flanges 91 are provided on the respective sides of the object 90 from the front surface to the back surface. In the example shown in FIG. 8, the flanges 91 are each provided in an upper portion of the side of the object 90. However, the flanges 91 may be provided in a lower portion, for example, and may not necessarily be provided in the upper portion. Further, when the rails 81a, 81b support the bottom surface of the object 90, the object 90 does necessarily have to be provided with the flanges 91.

As described above, the rack 80 supports both sides of the object 90 from below by the rails 81a, 81b. The object 90 can move in a front-rear direction in the rack 80 along the rails 81a, 81b. That is, the object 90 is housed in the rack 80 by pushing the object 90 toward the back surface of the rack 80. Conversely, the object 90 can be taken out from the rack 80 by pulling out the object 90 toward the front of the rack 80.

As shown in FIG. 8, a groove 92 for hooking the protruding portion 142 of the arm portion 140 is provided on the bottom surface of the object 90 at a predetermined position. The groove may have, for example, a semi-cylindrical shape having an axial direction that coincides with the direction of pulling out the object 90. The object 90 is, for example, a rectangular parallelepiped container, but the object 90 is not limited to this and may be any object. The object 90 can house any other object as a container.

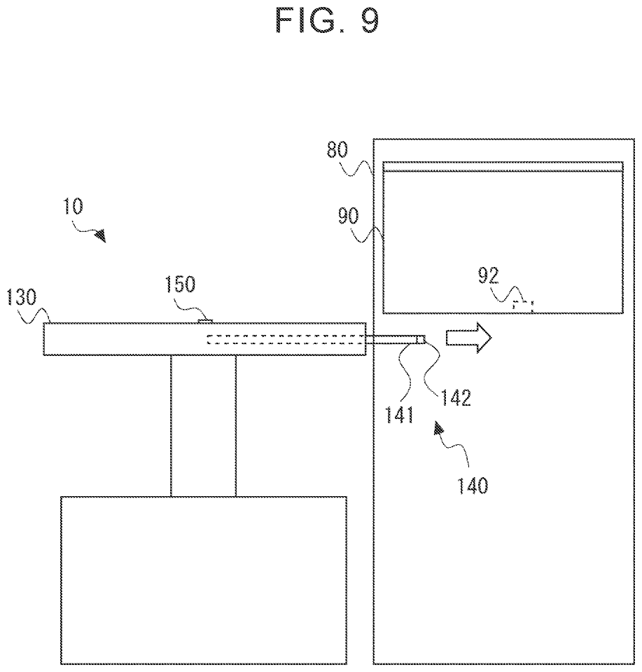

Next, the operation of the control unit 100 placing the object 90 on the top plate 130 will be described with reference to FIGS. 9 to 11. FIGS. 9 to 11 are schematic side views showing an operation of transferring the object 90 housed in the rack 80 to the top plate 130.

As shown in FIG. 9, first, the control unit 100 expands the arm portion 140 from the top plate 130 by a predetermined length to move the protruding portion 142 of the arm portion 140 toward the groove 92 on the bottom surface of the object 90. FIG. 9 is a schematic side view showing a state before the transport robot 10 takes out the object 90. The transport robot 10 may include a sensor such as a camera that detects the position of the groove 92 of the object 90, and may determine the length for expanding the arm portion 140 based on the detection result by the sensor.

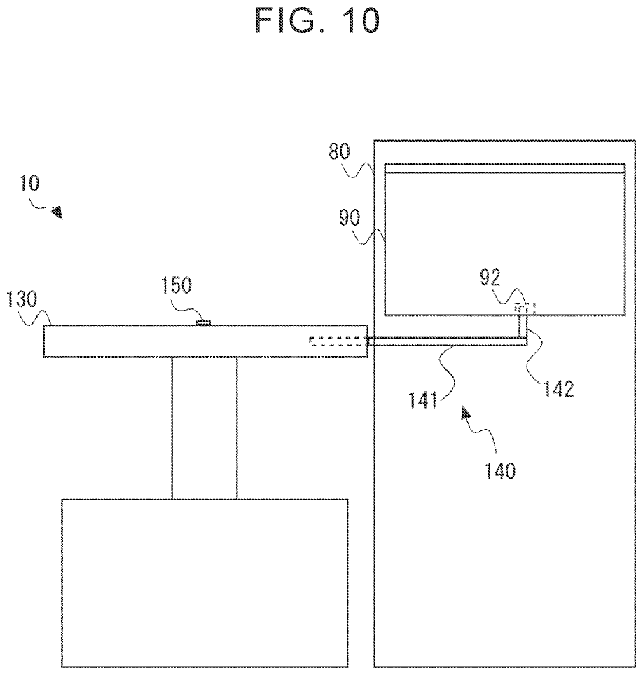

At this time, the direction of protrusion of the protruding portion 142 may be the horizontal direction. Next, as shown in FIG. 10, the control unit 100 rotates the protruding portion 142 with the shaft portion 141 of the arm portion 140 as a rotation axis. Specifically, the control unit 100 rotates the protruding portion 142 such that the protruding portion 142 faces upward. FIG. 10 is a schematic side view showing a state in which the transport robot 10 has engaged the object 90 with the arm portion 140. With this operation, the protruding portion 142 enters the groove 92 of the object 90. The control unit 100 may expand the arm portion 140 with the protruding portion 142 facing upward and then raise the top plate 130 to insert the protruding portion 142 into the groove 92.

Then, the control unit 100 contracts the arm portion 140 hooked in the groove 92. As a result, the object 90 is pulled out from the rack 80.

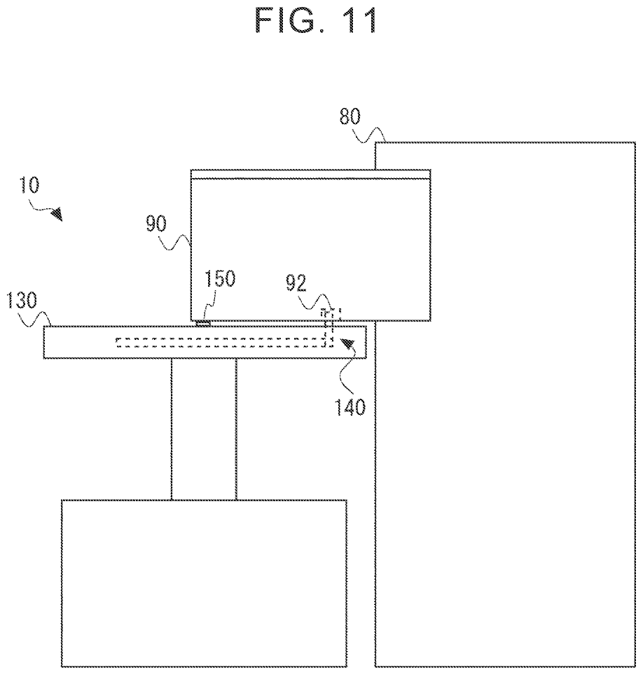

Here, the transport robot 10 first moves the object 90 to the detection position of the sensor 150, as shown in FIG. 11. FIG. 11 is a schematic side view showing a state in which the transport robot 10 has moved the object 90 to a predetermined position on the top plate 130. Then, the control unit 100 of the transport robot 10 confirms the detection result of the sensor 150. When the sensor 150 does not detect the object 90, it is considered that the object 90 is not properly pulled out. In such a case, when the pulling-out operation of the object 90 is continued, the transport robot 10 may drop the object 90. For example, when the groove 92 and the arm portion 140 are not sufficiently engaged with each other, the transport robot 10 may not be able to move the object 90 to the detection position of the sensor 150. The reason why the groove 92 and the arm portion 140 do not engage with each other is considered to be due to a case where the groove 92 is damaged or a case where foreign matter has entered the groove 92.

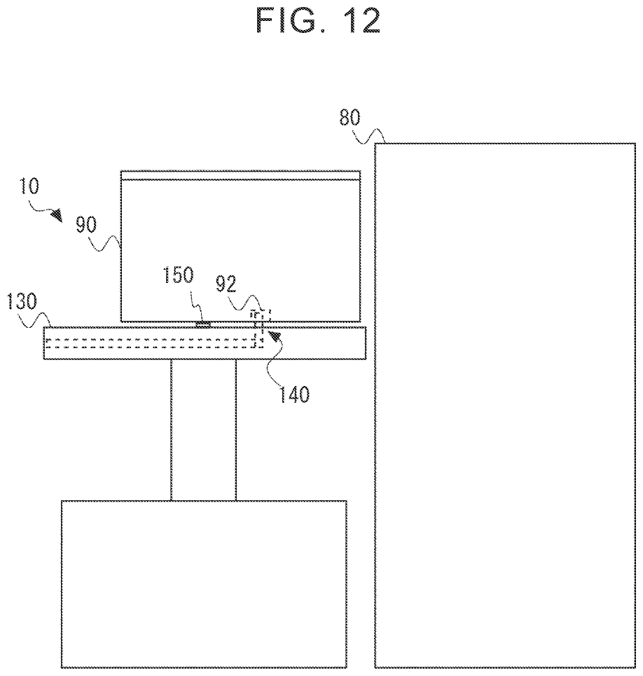

After confirming the detection result of the sensor 150, the transport robot 10 further moves the object 90 as shown in FIG. 12. FIG. 12 is a schematic side view showing a state in which the transport robot 10 has placed the object 90 on the top plate 130. On the other hand, when the object 90 is not detected by the sensor 150, the transport robot 10 performs a retry operation. For example, the transport robot 10 detects the position of the groove 92 again using the sensor or the like, and expands and contracts the arm portion 140 to pull out the object 90. The transport robot 10 may end the pulling-out process or output an alarm sound instead of the retry operation.

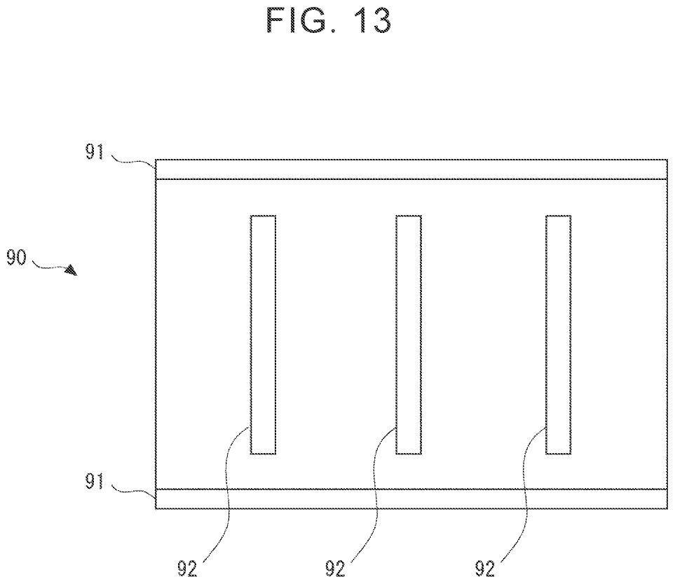

The number of grooves 92 of the object 90 may be one as shown in FIG. 8, but may be plural as shown in FIG. 13. FIG. 13 is a schematic bottom view illustrating the shape of the object 90. Specifically, the object 90 has a plurality of grooves 92 disposed in a perpendicular direction, that is, in a moving direction of the object 90. In this case, when the control unit 100 of the transport robot 10 moves the object 90 housed in the rack 80 to the top plate 130, the control unit 100 may hook the protruding portion 142 of the arm portion 140 in order from the groove 92 on the top plate 130 side, and repeat the pulling-out operation from the rack 80. Similarly, when the control unit 100 of the transport robot 10 moves the object 90 on the top plate 130 to the rack 80, the control unit 100 may hook the protruding portion 142 of the arm portion 140 in order from the groove 92 on the rack 80 side, and repeat the pushing-in operation to the rack 80. According to such a configuration, the length of the arm portion 140 can be shortened.

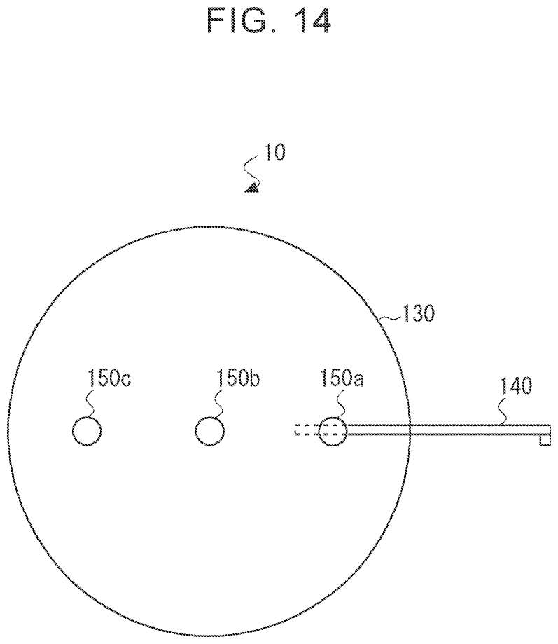

Further, a plurality of sensors 150 may be disposed on the top plate 130. FIG. 14 is a schematic plan view showing a state in which a plurality of sensors 150a, 150b, and 150c is disposed on the top plate 130 of the transport robot 10. The sensors 150a, 150b, and 150c are disposed along the direction in which the object 90 is moved. The number of sensors 150 may be two or four or more. The distance between the adjacent sensors 150 may match the distance between the adjacent grooves 92 of the object 90. The control unit 100 places the object 90 on the top plate 130 while confirming the detection results of the respective sensors 150a, 150b, and 150c. Similarly, the control unit 100 removes the object 90 from the top plate 130 while confirming the detection results of the respective sensors 150a, 150b, and 150c.

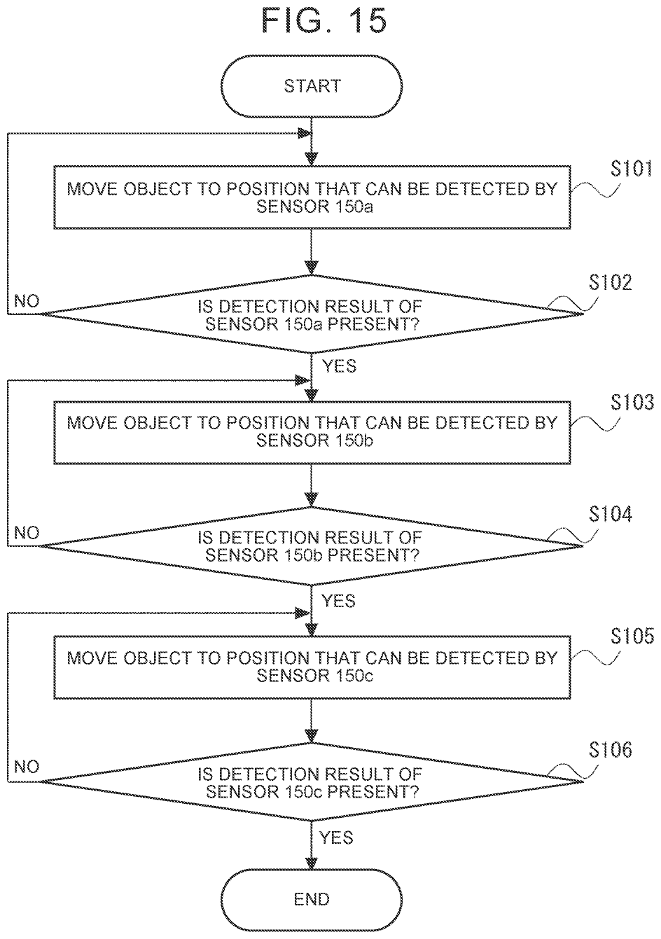

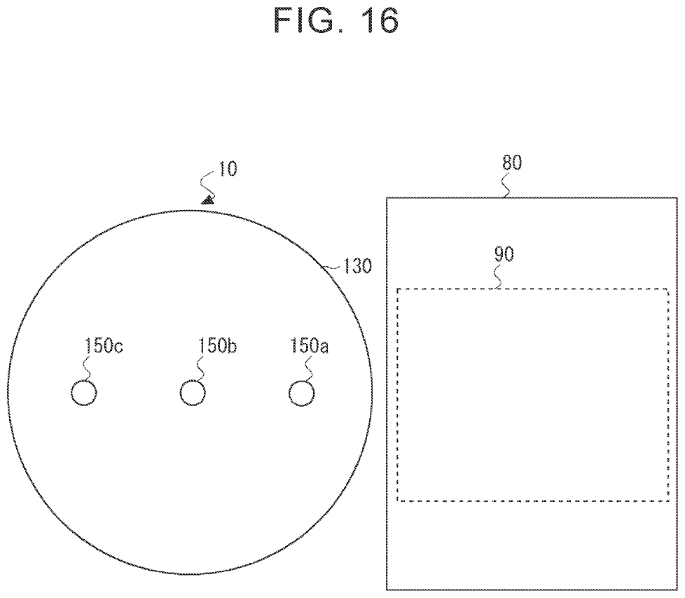

FIG. 15 is a flowchart illustrating a flow of a transport method according to the embodiment. FIG. 15 shows the flow of the operation of transferring the object 90 from the rack 80 to the top plate 130 in which the sensors 150a, 150b, and 150c are disposed. It is assumed that the transport robot 10 has moved to a predetermined position in front of the rack 80 in advance. FIG. 16 shows a state after the transport robot 10 has moved to the front of the rack 80 in which the object 90 is housed. That is, FIG. 16 is a schematic plan view showing a state before the transport robot 10 pulls out the object 90.

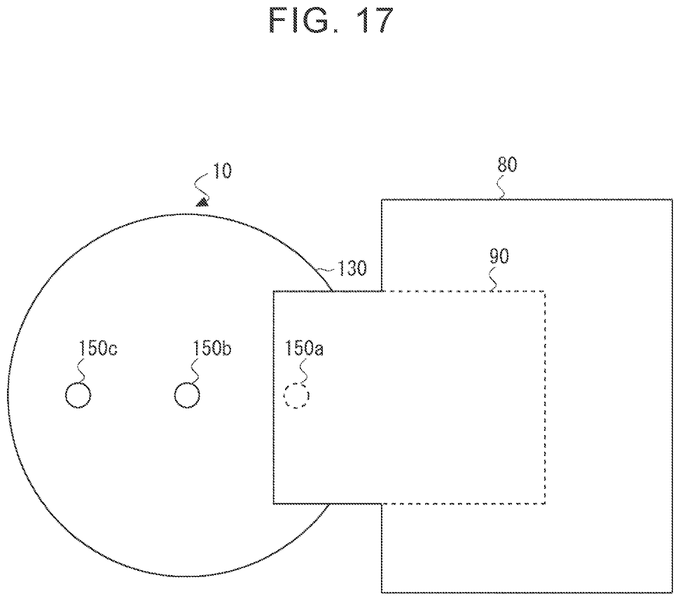

First, the control unit 100 of the transport robot 10 expands and contracts the arm portion 140 to move the object 90 to the detection position of the sensor 150a (step S101). FIG. 17 is a schematic plan view showing a state in which the object 90 has been moved to the detection position of the sensor 150a.

Next, the control unit 100 confirms the detection result of the sensor 150a and determines the presence or absence of the detection result of the sensor 150a (step S102). When the object 90 is not detected by the sensor 150a (No in step S102), the control unit 100 returns to the process of step S101. Instead of returning to the process of step S101, the control unit 100 may end the pulling-out process or output an alarm sound.

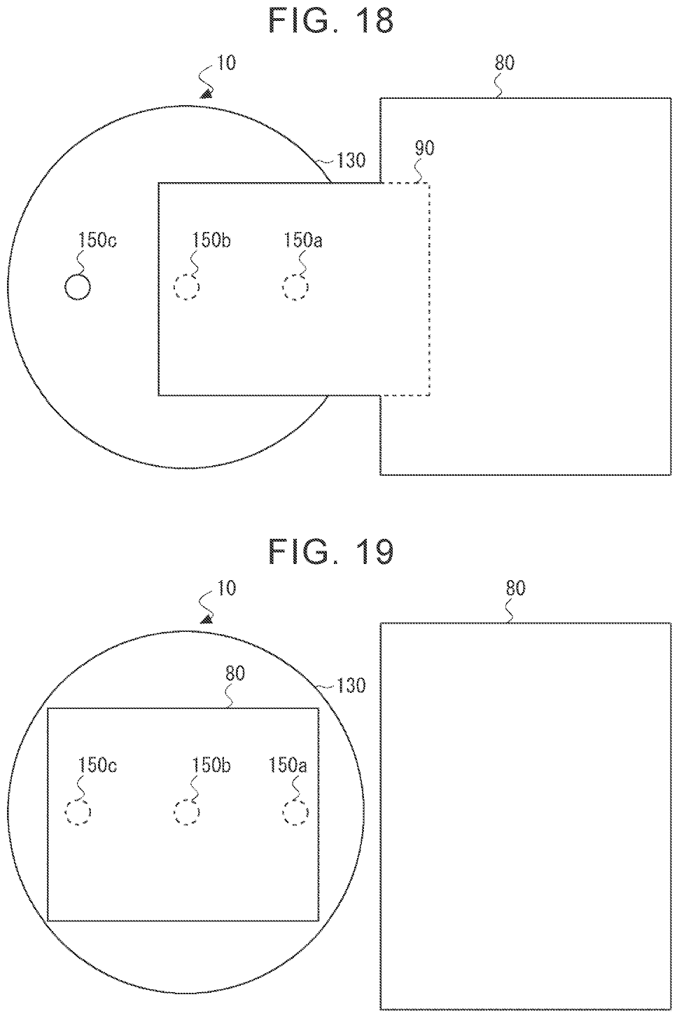

When the object 90 is detected by the sensor 150a (Yes in step S102), the control unit 100 further moves the object 90 to the detection position of the sensor 150b adjacent to the sensor 150a (step S103). FIG. 18 is a schematic plan view showing a state in which the object 90 has been moved to the detection range of the sensor 150b.

Here, the transport robot 10 may change the groove 92 to be engaged with the arm portion 140 from step S101. Further, the transport robot 10 may use the same groove as in step S101 and further contract the arm portion 140. Next, the control unit 100 confirms the detection result of the sensor 150b and determines the presence or absence of the detection result (step S104).

When the object 90 is not detected by the sensor 150b (No in step S104), the control unit 100 returns to the process of step S103 in the same manner as in step S102.

When the object 90 is detected by the sensor 150b (Yes in step S104), the control unit 100 moves the object 90 to the detection position of the sensor 150c (step S105) in the same manner as in step S103. FIG. 19 is a schematic plan view showing a state in which the object 90 has been moved to the detection position of the sensor 150c. Next, the control unit 100 confirms the detection result of the sensor 150c and determines the presence or absence of the detection result (step S106).

When the object 90 is not detected by the sensor 150c (No in step S106), the control unit 100 returns to the process of step S105 in the same manner as in steps S102 and S104. On the other hand, when the object 90 is detected by the sensor 150c (Yes in step S106), the control unit 100 ends the pulling-out process of the object 90.

With the above operations, the object 90 is placed on the top plate 130 from the rack 80. The transport robot 10 confirms the detection results of the sensors 150a, 150b, and 150c in order from the sensor 150a disposed on the rack 80 side.

On the other hand, when the object 90 is transferred from the top plate 130 to the rack 80, the control unit 100 first moves the object 90 to a position that is not detected by the sensor 150c, as shown in FIG. 18. Then, when the object 90 is no longer detected by the sensor 150c, the control unit 100 moves the object 90 to a position that is not detected by the sensor 150b, as shown in FIG. 17. Then, when the object 90 is no longer detected by the sensor 150b, the control unit 100 pushes the object 90 into the rack 80 as shown in FIG. 16. Finally, the control unit 100 confirms that the object 90 is no longer detected by the sensor 150a. The control unit 100 confirms the detection results of the sensors 150a, 150b, and 150c in order from the sensor 150c disposed on the side opposite to the rack 80 side.

Finally, the effects of the transport system according to the embodiment will be described in detail. The arm portion having a protruding portion can be used to move the object provided with a groove in and out of a rack. Here, when the groove is damaged or when foreign matter has entered the groove, it may not be possible to normally complete the loading and unloading of the object. For example, when the object is pulled out in the state in which the protruding portion is not in the groove, the object may be dropped.

The transport robot according to the embodiment moves the object based on the detection result of the sensor disposed on the top plate, which can reduce the risk of dropping the object. Further, when a plurality of sensors is disposed along the moving direction of the object, the transport system according to the embodiment can more accurately confirm the movement of the object and further reduce the risk of dropping the object.

The present disclosure is not limited to the above embodiment, and can be appropriately modified without departing from the spirit.

What is claimed is:

1. A transport system for transporting an object using a transport robot, wherein:
the transport robot includes
a top plate on which the object is placed,
an arm portion that moves the object in a horizontal direction so as to place the object on the top plate or remove the object from the top plate,
a sensor that is disposed on the top plate and detects that the object has reached a predetermined position on the top plate, and
a controller for controlling an operation of the arm portion; and
the controller places the object on the top plate based on a detection result of the sensor, or removes the object from the top plate based on the detection result of the sensor.

2. The transport system according to claim 1, wherein:
a plurality of the sensors is disposed on the top plate along a direction in which the object is moved; and
the controller places the object on the top plate while confirming the detection result of each of the sensors, or removes the object from the top plate while confirming the detection result of each of the sensors.

3. The transport system according to claim 1, further comprising a rack that houses the object, wherein when the object is transferred from the rack to the top plate, the controller confirms the detection result in order from the sensor disposed on a rack side, and when the object is transferred from the top plate to the rack, the controller confirms the detection result in order from the sensor disposed on a side opposite to the rack side.

4. The transport system according to claim 1, wherein the sensor is a photoreflector.

5. A transport method for transporting an object using a transport robot, wherein:
the transport robot includes
a top plate on which the object is placed,
an arm portion that moves the object in a horizontal direction so as to place the object on the top plate or remove the object from the top plate, and
a sensor that is disposed on the top plate and detects that the object has reached a predetermined position on the top plate; and
the transport method includes a step for placing the object on the top plate based on a detection result of the sensor, or removing the object from the top plate based on the detection result of the sensor.

6. The transport method according to claim 5, wherein:
a plurality of the sensors is disposed on the top plate along a direction in which the object is moved; and
the transport method includes a step for placing the object on the top plate while confirming the detection result of each of the sensors, or removing the object from the top plate while confirming the detection result of each of the sensors.
